(19) United States
(12) Patent Application Publication
(10) Pub. No.: US 2026/0260114 A1
(43) Pub. Date: Sep. 3, 2026

(54) METHOD, APPARATUS AND COMPUTER PROGRAM FOR ESTIMATING A CHANNEL BASED ON BASIS EXPANSION MODEL EXPANSION COEFFICIENTS DETERMINED BY A DEEP NEURAL NETWORK

(71) Applicant: Nokia Solutions and Networks Oy, Espoo (FI)

(72) Inventors: Carles NAVARRO, Aalborg (DK); Sajad REZAIE, Aalborg (DK); Ramoni OJEKUNLE ADEOGUN, Aalborg (DK); Gilberto BERARDINELLI, Aalborg (DK); Oana-Elena BARBU, Aalborg (DK)

(21) Appl. No.: 18/877,768

(22) PCT Filed: Jun. 27, 2022
(86) PCT No.: PCT/EP2022/067502

§ 371 Date: Dec. 20, 2024

(51) Int. Cl. G06N 3/084

(52) U.S. Cl. CPC G06N 3/084

(57) ABSTRACT

There is provided an apparatus for a receiver. The apparatus comprises means for obtaining received signal samples y, and means for determining, for the received signal samples y, a channel impulse response estimate ĥ based on i) at least one basis expansion model expansion coefficient, and ii) at least one basis function, wherein the at least one expansion model expansion coefficient is associated with a basis expansion model of a channel impulse response h. The apparatus also comprises means for performing an equalization using the received signal samples y, and the determined channel impulse response estimate ĥ.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus for a receiver, the apparatus comprising: means for obtaining received signal samples y; means for determining, for the received signal samples y, a channel impulse response estimate ĥ based on i) at least one basis expansion model expansion coefficient, and ii) at least one basis function, wherein the at least one expansion model expansion coefficient is associated with a basis expansion model of a channel impulse response h; and means for performing an equalization using the received signal samples y, and the determined channel impulse response estimate ĥ.

In an example, the means for performing an equalization comprises: means for determining a frequency domain channel response estimate Ĥ based on the channel impulse response estimate ĥ; means for determining an equalized symbol estimate \hat{x} based on i) the frequency domain channel response estimate Ĥ, and ii) the received signal samples y; and means for using the equalized symbol estimate \hat{x} to estimate a transmitted codeword associated with the received signal samples y.

In an example, the at least one basis function comprises at least one of: a discrete prolate spheroidal function, a discrete cosine transform, a discrete Fourier transform, and a discrete wavelet transform.

In an example, the means for determining, for the received signal samples y, a channel impulse response estimate ĥ comprises means for determining, for each sample within the received signal samples y, a channel impulse response estimate ĥ.

In examples, the means for using the equalized symbol estimate ĥ comprises: means for determining a log-likelihood ratio using the equalized symbol estimate ĥ; and means for utilising the log-likelihood ratio to determine the estimate of the transmitted codeword associated with received signal samples y.

In an example, the received signal samples y is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the received signal samples y comprises a first channel and a second channel for real and imaginary parts of the signal y respectively.

In an example, the means for determining, for the received signal samples y, the channel impulse response estimate ĥ comprises a deep neural network.

In an example, the deep neural network comprises a convolutional neural network.

In an example, the deep neural network receives, as inputs: the received signal samples y, wherein the received signal samples y includes orthogonal frequency division multiplexing symbol symbols; and a pilot map μₓ describing values and positions of pilot resource elements within the orthogonal frequency division multiplexing symbol symbols.

In an example, the deep neural network receives, as an input: a trust map

$${σ}_{x}^{2}$$

describing a confidence level of values and positions of data resource elements within the orthogonal frequency division multiplexing symbols of the received signal samples y.

In an example, the apparatus comprises: means for determining the at least one basis expansion model expansion coefficient of the basis expansion model using i) the received signal samples y, and at least one of: ii) the pilot map μₓ, and iii) the trust map

$${σ}_{x}^{2} .$$

In an example, the pilot map μₓ is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the pilot map μₓ comprises a first channel and a second channel for real and imaginary parts of the signal y respectively, wherein elements of the pilot map μₓ have: a value set to ‘0’ for elements that correspond to data resource elements of the received signal samples y, and a value corresponding to a respective pilot symbol for elements that correspond to pilot resource elements of the received signal samples y.

In an example, the trust map

$${σ}_{x}^{2}$$

is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the trust map

$${σ}_{x}^{2}$$

comprises a single channel for real parts of the received signal samples y, and wherein elements of the trust map

$${σ}_{x}^{2}$$

have a value set to ‘1’ for elements that correspond to data resource elements of the received signal samples y, and a value set to ‘0’ for elements that correspond to pilot resource elements of the received signal samples y.

In an example, the deep neural network comprises a series of two-dimensional convolutional blocks, each two-dimensional convolutional blocks includes: a two-dimensional convolutional layer configured to implement a two-dimensional filter that operates as a sliding window over the input tensor, taking a two-dimensional tensor as an input, and providing an output two-dimensional tensor; a two-dimensional batch normalization layer configured to account for different scales of the inputs to the deep neural network, by taking a tensor as an input and outputting a tensor of the same dimension, that has been normalized with an average magnitude obtained over a batch; and a two-dimensional rectified linear unit configured to introduce a non-linear transformation, to allow the deep neural network to approximate mathematical functions, wherein the two-dimensional rectified linear unit operates element-by-element on the input, so that an output is the same size as the input.

In an example, the deep neural network comprises: a flattening layer configured to convert a two-dimensional tensor provided by a last two-dimensional convolutional block of the series of two-dimensional convolutional blocks into a one-dimensional tensor.

In an example, the deep neural network comprises: a dense layer configured to, using the one-dimensional tensor output from the flattening layer as an input, output the at least one basis expansion model expansion coefficient.

In an example, the deep neural network comprises an expansion layer configured to provide the channel impulse response estimate ĥ using i) the at least one basis expansion coefficient, and ii) the at least one basis function.

In an example, the deep neural network is trained using, at least one of: data obtained from field measurements, data obtained from live networks, and data generated using simulation tools.

In an example, the deep neural network is trained offline based on a training dataset, using a stochastic gradient descent-based learning algorithm, with a learning rate progressively decreasing over training iterations.

In an example, the deep neural network is trained based on an end-to-end strategy using: means for determining, for a training received signal samples, a channel impulse response estimate ĥ based on a basis expansion model of a channel impulse response h; means for determining a frequency domain channel response estimate Ĥ based on the channel impulse response estimate ĥ; means for determining an equalized symbol estimate \hat{x} based on i) the frequency domain channel response estimate Ĥ, and ii) the training received signal samples; and means for using the equalized symbol estimate \hat{x} to estimate a transmitted codeword associated with the training received signal samples; means for determining a probability of a codeword estimate p [symbol] based on the equalized symbol estimate \hat{x}; means for determining a binary cross-entropy loss based on the probability of a codeword estimate p [symbol] and a codeword c; and means for adjusting one or more of: the convolutional block, and the dense layer, based on the binary cross-entropy loss.

In an example, the deep neural network is trained based on a regression based strategy using: means for determining, for a training received signal samples, a channel impulse response estimate ĥ based on a basis expansion model of a channel impulse response h; means for determining a mean squared error based on the channel impulse response estimate ĥ and the channel impulse response h; and means for adjusting one or more of: the convolutional block, and the dense layer, based on the mean squared error.

In an example, the frequency domain equalized symbol estimate \hat{x} is determined as follows:

$$\hat{x} = {( \hat{H} {\hat{H}}^{H} )}^{- 1} {\hat{H}}^{H} y$$

In an example, the frequency domain equalized symbol estimate \hat{x} is determined as follows:

$$\hat{x} = {( \hat{H} {\hat{H}}^{H} + {σ}_{w}^{2} I )}^{- 1} {\hat{H}}^{H} y$$

In an example, the frequency domain equalized symbol estimate \hat{x} is determined as follows:

$$\text{?} = \frac{{y}_{k}}{{[ \hat{H} ]}_{k , k}}$$

In an example, the frequency domain channel response estimate Ĥ and the frequency domain equalized symbol estimate \hat{x} are determined iteratively, wherein for each iteration: the pilot map μₓ is updated by setting the values corresponding to data resource elements to a mean of the estimate of the corresponding data symbol; the trust map

$${σ}_{x}^{2}$$

is updated by setting the values corresponding to data resource elements to a variance of the estimate of the corresponding data symbol; and an estimate of inter-carrier interference is removed from the received signal samples y before determining the frequency domain equalized symbol estimate \hat{x}.

According to an aspect, there is provided a method performed by a receiver, the method comprising: obtaining received signal samples y; determining, for the received signal samples y, a channel impulse response estimate ĥ based on i) at least one basis expansion model expansion coefficient, and ii) at least one basis function, wherein the at least one expansion model expansion coefficient is associated with a basis expansion model of a channel impulse response h; and performing an equalization using the received signal samples y, and the determined channel impulse response estimate ĥ.

In an example, the performing an equalization comprises: determining a frequency domain channel response estimate Ĥ based on the channel impulse response estimate ĥ; determining an equalized symbol estimate \hat{x} based on i) the frequency domain channel response estimate Ĥ, and ii) the received signal samples y; and using the equalized symbol estimate \hat{x} to estimate a transmitted codeword associated with the received signal samples y.

In an example, the at least one basis function comprises at least one of: a discrete prolate spheroidal function, a discrete cosine transform, a discrete Fourier transform, and a discrete wavelet transform.

In an example, the determining, for the received signal samples y, a channel impulse response estimate ĥ comprises determining, for each sample within the received signal samples y, a channel impulse response estimate ĥ.

In examples, the using the equalized symbol estimate \hat{x} comprises: determining a log-likelihood ratio using the equalized symbol estimate \hat{x}; and utilising the log-likelihood ratio to determine the estimate of the transmitted codeword associated with received signal samples y.

In an example, the received signal samples y is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the received signal samples y comprises a first channel and a second channel for real and imaginary parts of the signal y respectively.

In an example, the determining, for the received signal samples y, the channel impulse response estimate ĥ is performed by a deep neural network of the receiver.

In an example, the deep neural network comprises a convolutional neural network.

In an example, the method comprises receiving, at the deep neural network, as inputs: the received signal samples y, wherein the received signal samples y includes orthogonal frequency division multiplexing symbol symbols; and a pilot map μₓ describing values and positions of pilot resource elements within the orthogonal frequency division multiplexing symbol symbols.

In an example, the method comprises receiving, at the deep neural network, as an input: a trust map

$${σ}_{x}^{2}$$

describing a confidence level of values and positions of data resource elements within the orthogonal frequency division multiplexing symbols of the received signal samples y.

In an example, the method comprises: determining the at least one basis expansion model expansion coefficient of the basis expansion model using i) the received signal samples y, and at least one of: ii) the pilot map μₓ, and iii) the trust map

$${σ}_{x}^{2} .$$

In an example, the pilot map μₓ is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the pilot map μₓ comprises a first channel and a second channel for real and imaginary parts of the signal y respectively, wherein elements of the pilot map μₓ have: a value set to ‘0’ for elements that correspond to data resource elements of the received signal samples y, and a value corresponding to a respective pilot symbol for elements that correspond to pilot resource elements of the received signal samples y.

In an example, the trust map

$${σ}_{x}^{2}$$

is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the trust map

$${σ}_{x}^{2}$$

comprises a single channel for real parts of the received signal samples y, and wherein elements of the trust map

$${σ}_{x}^{2}$$

have a value set to ‘1’ for elements that correspond to data resource elements of the received signal samples y, and a value set to ‘0’ for elements that correspond to pilot resource elements of the received signal samples y.

In an example, the deep neural network comprises a series of two-dimensional convolutional blocks, each two-dimensional convolutional blocks includes: a two-dimensional convolutional layer configured to implement a two-dimensional filter that operates as a sliding window over the input tensor, taking a two-dimensional tensor as an input, and providing an output two-dimensional tensor; a two-dimensional batch normalization layer configured to account for different scales of the inputs to the deep neural network, by taking a tensor as an input and outputting a tensor of the same dimension, that has been normalized with an average magnitude obtained over a batch; and a two-dimensional rectified linear unit configured to introduce a non-linear transformation, to allow the deep neural network to approximate mathematical functions, wherein the two-dimensional rectified linear unit operates element-by-element on the input, so that an output is the same size as the input.

In an example, the deep neural network comprises: a flattening layer configured to convert a two-dimensional tensor provided by a last two-dimensional convolutional block of the series of two-dimensional convolutional blocks into a one-dimensional tensor.

In an example, the deep neural network comprises: a dense layer configured to, using the one-dimensional tensor output from the flattening layer as an input, output the at least one basis expansion model expansion coefficient.

In an example, the deep neural network comprises an expansion layer configured to provide the channel impulse response estimate ĥ using i) the at least one basis expansion coefficient, and ii) the at least one basis function.

In an example, the deep neural network is trained using, at least one of: data obtained from field measurements, data obtained from live networks, and data generated using simulation tools.

In an example, the deep neural network is trained offline based on a training dataset, using a stochastic gradient descent-based learning algorithm, with a learning rate progressively decreasing over training iterations.

In an example, the method comprises training the deep neural network with an end-to-end strategy by: determining, for a training received signal samples, a channel impulse response estimate ĥ based on a basis expansion model of a channel impulse response h; determining a frequency domain channel response estimate Ĥ based on the channel impulse response estimate ĥ; determining an equalized symbol estimate \hat{x} based on i) the frequency domain channel response estimate Ĥ, and ii) the training received signal samples; and using the equalized symbol estimate \hat{x} to estimate a transmitted codeword associated with the training received signal samples; determining a probability of a codeword estimate p [symbol] based on the equalized symbol estimate \hat{x}; determining a binary cross-entropy loss based on the probability of a codeword estimate p [symbol] and a codeword c; and adjusting one or more of: the convolutional block, and the dense layer, based on the binary cross-entropy loss.

In an example, the method comprises training the deep neural network with a regression based strategy by: determining, for a training received signal samples, a channel impulse response estimate ĥ based on a basis expansion model of a channel impulse response h; determining a mean squared error based on the channel impulse response estimate ĥ and the channel impulse response h; and adjusting one or more of: the convolutional block, and the dense layer, based on the mean squared error.

In an example, the frequency domain equalized symbol estimate \hat{x} is determined as follows:

$$\hat{x} = {( \hat{H} {\hat{H}}^{H} )}^{- 1} {\hat{H}}^{H} y$$

In an example, the frequency domain equalized symbol estimate \hat{x} is determined as follows:

$$\hat{x} = {( \hat{H} {\hat{H}}^{H} + {σ}_{w}^{2} I )}^{- 1} {\hat{H}}^{H} y$$

In an example, the frequency domain equalized symbol estimate \hat{x} is determined as follows:

$$\text{?} = \frac{{y}_{k}}{{[ \hat{H} ]}_{k , k}}$$

In an example, the frequency domain channel response estimate Ĥ and the frequency domain equalized symbol estimate \hat{x} are determined iteratively, wherein for each iteration: the pilot map μₓ is updated by setting the values corresponding to data resource elements to a mean of the estimate of the corresponding data symbol; the trust map

$${σ}_{x}^{2}$$

is updated by setting the values corresponding to data resource elements to a variance of the estimate of the corresponding data symbol; and an estimate of inter-carrier interference is removed from the received signal samples y before determining the frequency domain equalized symbol estimate \hat{x}.

According to an aspect, there is provided an apparatus comprising: one or more processors, and memory storing instructions that, when executed by the one or more processors, cause the apparatus to perform: obtaining received signal samples y; determining, for the received signal samples y, a channel impulse response estimate ĥ based on i) at least one basis expansion model expansion coefficient, and ii) at least one basis function, wherein the at least one expansion model expansion coefficient is associated with a basis expansion model of a channel impulse response h; and performing an equalization using the received signal samples y, and the determined channel impulse response estimate ĥ.

In an example, the apparatus caused to perform the performing an equalization comprises: determining a frequency domain channel response estimate Ĥ based on the channel impulse response estimate ĥ; determining an equalized symbol estimate \hat{x} based on i) the frequency domain channel response estimate Ĥ, and ii) the received signal samples y; and using the equalized symbol estimate \hat{x} to estimate a transmitted codeword associated with the received signal samples y.

In an example, the at least one basis function comprises at least one of: a discrete prolate spheroidal function, a discrete cosine transform, a discrete Fourier transform, and a discrete wavelet transform.

In an example, the apparatus caused to perform the determining, for the received signal samples y, a channel impulse response estimate ĥ comprises determining, for each sample within the received signal samples y, a channel impulse response estimate ĥ.

In examples, the apparatus caused to perform the using the equalized symbol estimate \hat{x} comprises: determining a log-likelihood ratio using the equalized symbol estimate \hat{x}; and utilising the log-likelihood ratio to determine the estimate of the transmitted codeword associated with received signal samples y.

In an example, the received signal samples y is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the received signal samples y comprises a first channel and a second channel for real and imaginary parts of the signal y respectively.

In an example, the apparatus caused to perform the determining, for the received signal samples y, the channel impulse response estimate ĥ is performed by a deep neural network of the receiver.

In an example, the deep neural network comprises a convolutional neural network.

In an example, the apparatus is caused to perform: receiving, at the deep neural network, as inputs: the received signal samples y, wherein the received signal samples y includes orthogonal frequency division multiplexing symbol symbols; and a pilot map μₓ describing values and positions of pilot resource elements within the orthogonal frequency division multiplexing symbol symbols.

In an example, the apparatus is caused to perform: receiving, at the deep neural network, as an input: a trust map

$${σ}_{x}^{2}$$

describing a confidence level of values and positions of data resource elements within the orthogonal frequency division multiplexing symbols of the received signal samples y.

In an example, the apparatus is caused to perform: determining the at least one basis expansion model expansion coefficient of the basis expansion model using i) the received signal samples y, and at least one of: ii) the pilot map μₓ, and iii) the trust map

$${σ}_{x}^{2} .$$

In an example, the pilot map μₓ is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the pilot map μₓ comprises a first channel and a second channel for real and imaginary parts of the signal y respectively, wherein elements of the pilot map μₓ have: a value set to ‘0’ for elements that correspond to data resource elements of the received signal samples y, and a value corresponding to a respective pilot symbol for elements that correspond to pilot resource elements of the received signal samples y.

In an example, the trust map

$${σ}_{x}^{2}$$

is a tensor with dimension equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot, wherein the trust map

$${σ}_{x}^{2}$$

comprises a single channel for real parts of the received signal samples y, and wherein elements of the trust map

$${σ}_{x}^{2}$$

have: a value set to ‘1’ for elements that correspond to data resource elements of the received signal samples y, and a value set to ‘0’ for elements that correspond to pilot resource elements of the received signal samples y.

In an example, the deep neural network comprises a series of two-dimensional convolutional blocks, each two-dimensional convolutional blocks includes: a two-dimensional convolutional layer configured to implement a two-dimensional filter that operates as a sliding window over the input tensor, taking a two-dimensional tensor as an input, and providing an output two-dimensional tensor; a two-dimensional batch normalization layer configured to account for different scales of the inputs to the deep neural network, by taking a tensor as an input and outputting a tensor of the same dimension, that has been normalized with an average magnitude obtained over a batch; and a two-dimensional rectified linear unit configured to introduce a non-linear transformation, to allow the deep neural network to approximate mathematical functions, wherein the two-dimensional rectified linear unit operates element-by-element on the input, so that an output is the same size as the input.

In an example, the deep neural network comprises: a flattening layer configured to convert a two-dimensional tensor provided by a last two-dimensional convolutional block of the series of two-dimensional convolutional blocks into a one-dimensional tensor.

In an example, the deep neural network comprises: a dense layer configured to, using the one-dimensional tensor output from the flattening layer as an input, output the at least one basis expansion model expansion coefficient.

In an example, the deep neural network comprises an expansion layer configured to provide the channel impulse response estimate ĥ using i) the at least one basis expansion coefficient, and ii) the at least one basis function.

In an example, the deep neural network is trained using, at least one of: data obtained from field measurements, data obtained from live networks, and data generated using simulation tools.

In an example, the deep neural network is trained offline based on a training dataset, using a stochastic gradient descent-based learning algorithm, with a learning rate progressively decreasing over training iterations.

In an example, the apparatus is caused to perform: training the deep neural network with an end-to-end strategy by: determining, for a training received signal samples, a channel impulse response estimate ĥ based on a basis expansion model of a channel impulse response h; determining a frequency domain channel response estimate Ĥ based on the channel impulse response estimate ĥ; determining an equalized symbol estimate \hat{x} based on i) the frequency domain channel response estimate Ĥ, and ii) the training received signal samples; and using the equalized symbol estimate \hat{x} to estimate a transmitted codeword associated with the training received signal samples; determining a probability of a codeword estimate p [symbol] based on the equalized symbol estimate \hat{x}; determining a binary cross-entropy loss based on the probability of a codeword estimate p [symbol] and a codeword c; and adjusting one or more of: the convolutional block, and the dense layer, based on the binary cross-entropy loss.

In an example, the apparatus is caused to perform: training the deep neural network with a regression based strategy by: determining, for a training received signal samples, a channel impulse response estimate ĥ based on a basis expansion model of a channel impulse response h; determining a mean squared error based on the channel impulse response estimate ĥ and the channel impulse response h; and adjusting one or more of: the convolutional block, and the dense layer, based on the mean squared error.

In an example, the frequency domain equalized symbol estimate \hat{x} is determined as follows:

$$\hat{x} = {( \hat{H} {\hat{H}}^{H} )}^{- 1} {\hat{H}}^{H} y$$

In an example, the frequency domain equalized symbol estimate \hat{x} is determined as follows:

$$\hat{x} = {( \hat{H} {\hat{H}}^{H} + {σ}_{w}^{2} I )}^{- 1} {\hat{H}}^{H} y$$

In an example, the frequency domain equalized symbol estimate \hat{x} is determined as follows:

$$\text{?} = \frac{{y}_{k}}{{[ \hat{H} ]}_{k , k}}$$

In an example, the frequency domain channel response estimate Ĥ and the frequency domain equalized symbol estimate \hat{x} are determined iteratively, wherein for each iteration: the pilot map μₓ is updated by setting the values corresponding to data resource elements to a mean of the estimate of the corresponding data symbol; the trust map

$${σ}_{x}^{2}$$

is updated by setting the values corresponding to data resource elements to a variance of the estimate of the corresponding data symbol; and an estimate of inter-carrier interference is removed from the received signal samples y before determining the frequency domain equalized symbol estimate \hat{x}.

According to an aspect, there is provided computer program comprising computer executable instructions which when run on one or more processors perform: obtaining received signal samples y; determining, for the received signal samples y, a channel impulse response estimate ĥ based on i) at least one basis expansion model expansion coefficient, and ii) at least one basis function, wherein the at least one expansion model expansion coefficient is associated with a basis expansion model of a channel impulse response h; and performing an equalization using the received signal samples y, and the determined channel impulse response estimate ĥ.

A computer product stored on a medium may cause an apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations

AF: Application Function
AI: Artificial Intelligence
AMF: Access Management Function
AN: Access Network
BEM: Basis Expansion Model
BS: Base Station
CN: Core Network
CFR: Channel Frequency Response
CIR: Channel Impulse Response
CNN: Convolutional Neural Network
DPSS: Discrete Prolate Spheroidal Sequence
DL: Downlink
DMRS: Demodulation Reference Signal
eNB: eNodeB
gNB: gNodeB
HST: High-Speed Train
ICI: Inter-Carrier Interference
IIoT: Industrial Internet of Things
LLR: Log-Likelihood Ratio
LTE: Long Term Evolution
NEF: Network Exposure Function
NG-RAN: Next Generation Radio Access Network
NF: Network Function
NR: New Radio
NRF: Network Repository Function
NW: Network
ML: Machine Learning
MS: Mobile Station
OFDM: Orthogonal Frequency Division Multiplexing
PCF Policy Control Function
PLMN: Public Land Mobile Network
PTRS: Phase Tracking Reference Signal
RAN: Radio Access Network
RE: Resource Element
RF: Radio Frequency
RRH: Remote Radio Head
RRM: Radio Resource Management
SCS: Subcarrier Spacing
SMF: Session Management Function
TRS: Tracking Reference Signal
UE: User Equipment
UDR: Unified Data Repository
UDM: Unified Data Management
UL: Uplink
UPF: User Plane Function
3GPP: 3^{rd} Generation Partnership Project
5G: 5^{th} Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a graphical representation of inter-carrier interference on OFDM reception as the channel rate of variation grows;

FIG. 5 shows a schematic representation of a hybrid receiver;

FIG. 6 shows a schematic representation of a transmitter in communication with a receiver using OFDM;

FIG. 7 shows a schematic representation of functional blocks within a receiver;

FIG. 8 shows a schematic representation of function blocks of a deep neural network used to determine channel impulse response estimates;

FIG. 9 shows a schematic representation of an end-to-end training loop for a deep neural network;

FIG. 10 shows a schematic representation of regression-based training loop for a deep neural network;

FIG. 11 shows a graphical representations of the performance of a receiver when there is low, high, and very high user equipment mobility conditions;

FIG. 12 shows another example method flow diagram performed by a receiving device; and

FIG. 13 shows a schematic representation of a non-volatile memory medium storing instructions which when executed by a processor allow a processor to perform one or more of the steps of the method of FIG. 12.

### DETAILED DESCRIPTION

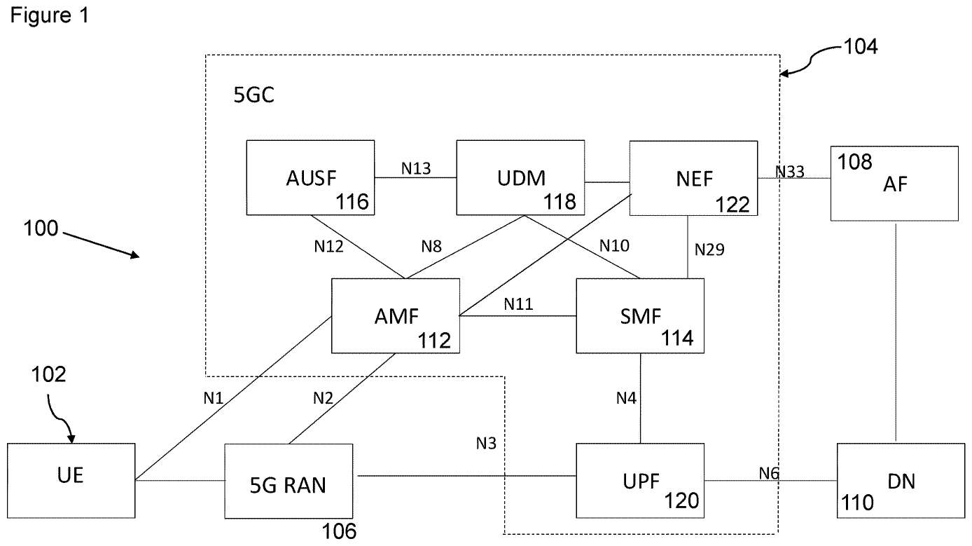

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of disclose, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprises a device 102 such as user equipment or terminal, a 5G access network (5G-AN) 106, a 5G core network (5GC) 104, one or more network functions (NF), one or more application function (AF) 108 and one or more data networks (DN) 110.

The 5G-AN 106 may comprise one or more gNodeB (gNB) distributed unit functions connected to one or more gNodeB (gNB) centralized unit functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 6G, 4G, 3G and other 3GPP standards.

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a station or access point, and transmit and/or receive communications on the carrier.

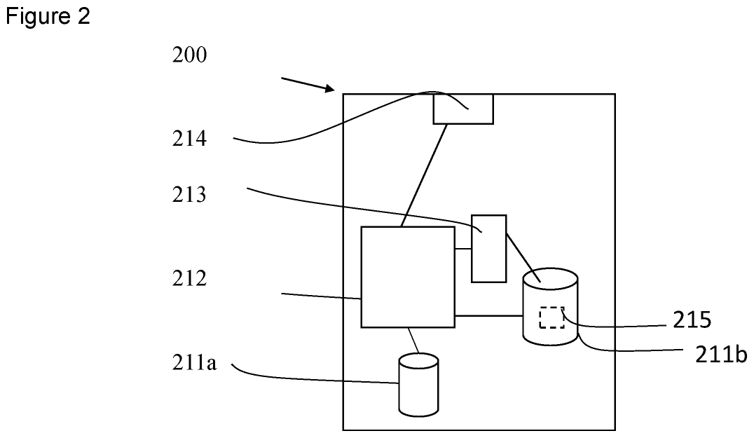

FIG. 2 illustrates an example of a control apparatus 200 for controlling a function of the 5G-AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

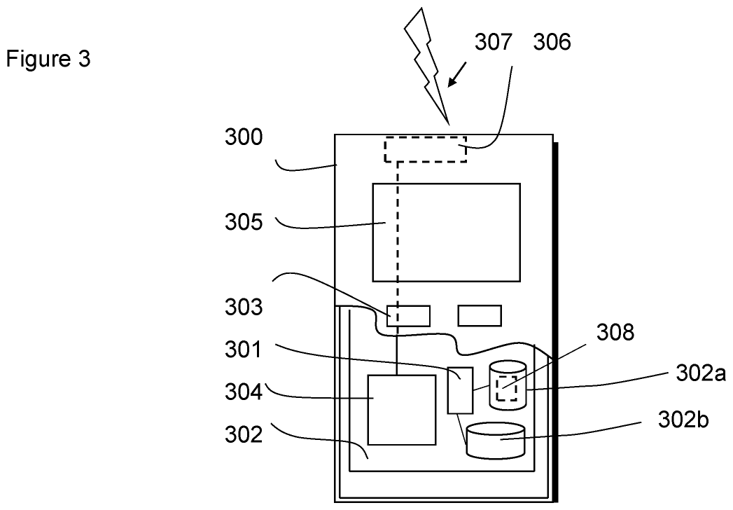

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more of the follow examples are related to receiver design, that may be applicable for high-speed scenarios. In some examples, the receivers use artificial intelligence (AI) or machine learning (ML) algorithms.

Traditionally, ML and/or AI techniques have been used in, for example: radio network management, fault detection, failure monitoring, intrusion detection, etc. In the past, there have been many proposals in open literature on how to use ML techniques to implement and/or optimise RAN functions. More specifically, using ML techniques for physical (PHY), medium access control (MAC) and radio resource management (RRM) functions such as, for example, channel encoding/decoding, channel estimation/prediction, resource allocation/scheduling, mobility optimisation.

In general, the common proposal of these studies is to ‘replace traditional rule-based techniques with ML-based techniques’ in order to achieve system gains either in terms of radio capacity (increased spectral efficiency or signalling reduction) and reliability, or complexity reduction. ML-assisted L1 and L2 mechanisms are also being investigated in 3GPP RAN1 and RAN2 standardisation.

In 3GPP releases TS 38.854 and R4-2111282 there are lists of the most recent high speed train (HST) performance requirements with UE and gNB capabilities.

TS 38.854 states that 5G NR operating in millimeter wave bands (i.e., Frequency Range 2 (FR2)) is recognized as the technology capable of providing ultra-high data-rate transmission, thanks to the availability of enormous amount of bandwidth in FR2 and the advanced 5G NR design for FR2 beamforming-based operation. Inspired by the successful commercial FR2 deployment globally, more potential 5G NR deployment scenarios in FR2 draw attention from the industry. Among those scenarios identified, HST scenario has the special importance, because of the fast-expanding HST systems worldwide deployed and the great demands of high-speed connections from passengers and HST special services. This triggers the new and challenging demand for 5G NR FR2 HST scenario. In existing study and work items led by 3GPP RAN4 (for either LTE or NR), high speed train scenarios under consideration have the operating bands up to 3.5 GHZ, however no existing works studied the more challenging millimetre wave frequency range 2, in which Doppler shift and Doppler spread will be further severe (e.g., for 240 km/h with 28 GHz, the Doppler shift is about 6.22 kHz) and more challenging to radio resource management. Specifically, the existing FR2 RRM and demodulation requirements has not yet taken into account the impact of high speed in the above-mentioned scenario, where the channel model and mobility scenario need further study and the demodulation, measurement, mobility and beam management related requirements require to be further specified. It should be noted that user equipment considered in 5G NR FR2 HST scenario is vehicle-roof mounted customer-premises equipment (CPE), which are expected to communicate with track-side deployed gNBs for the backhaul link and to further provide on-board broadband connections to user terminals and/or for other train-specific demands as access link. There is a need to specify NR UE RF requirements, UE RRM requirements and BS/UE performance requirements for high-speed train scenario with up to 350 km/h in Rel-17.

Furthermore, in the document R4-2111282 there are discussions of companies' observations on maximum speed feasibility, which include:

It is feasible to support maximum speed with 350 km/h for downlink with a tracking reference signal (TRS) (4 symbol interval) for frequency offset tracking under unidirectional remote radio head (RRH) deployment with 120 KHz subcarrier spacing (SCS).

It is feasible to support maximum speed with 350 km/h for downlink with TRS (4 symbol interval)+synchronisation signal block (SSB) for frequency offset tracking under unidirectional and bi-directional RRH deployment with 120 KHz SCS.

It is feasible to support maximum speed with 350 km/h for downlink with TRS (4 symbol interval)+phase tracking reference signal (PTRS) (L=1) for frequency offset tracking under bi-directional RRH deployment with 120 KHz SCS.

It is feasible to support maximum speed with 350 km/h for downlink with PTRS or DMRS (1+1+1)+PTRS (L=1,K=2) configuration used for frequency offset tracking under single tap propagation conditions with 120 KHz SCS.

Orthogonal frequency division multiplexing (OFDM) is a type of digital transmission and a method of encoding digital data on multiple carrier frequencies. OFDM allows for spectrally efficient transmission of data with simple equalization techniques under favourable channel conditions, namely when the excess delay of the channel is contained within the cyclic prefix (CP) duration, and the channel response is nearly constant over the OFDM symbol duration. Under such conditions and after classical OFDM receiver processing, the signals transmitted at each of the system subcarriers can be near perfectly separated from that of other system subcarriers. Effectively, each subcarrier becomes an independent flat fading channel and the signal transmitted over it is received free of interference from other subcarriers.

Under harsh channel conditions, such as very fast-varying channels, the aforementioned orthogonality among subcarriers is no longer preserved. Instead, adjacent subcarriers may “leak” interference over its neighbouring subcarriers. Indeed, the signal received after CP discarding and Fourier fast transform (FFT) receiver processing reads:

$$y = H x + w$$

Wherein x is a vector containing the symbols transmitted at all subcarriers, y is a vector containing the received signal at all subcarriers, and w is a vector of additive white Gaussian noise (AWGN). The matrix H represents the channel effect: its (k,k′)th entry maps the symbol transmitted at the k′th subcarrier to the signal observed in the kth received subcarrier.

In this equation, x is column a vector, i.e., a 1-D matrix comprising elements made of complex numbers. In this equation, y is a column vector, i.e., a 1-D matrix comprising elements made of complex numbers. In this equation, w is a column vector, i.e., a 1-D matrix comprising elements made of complex numbers. In this equation, H is a 2-D matrix comprising elements made of complex numbers.

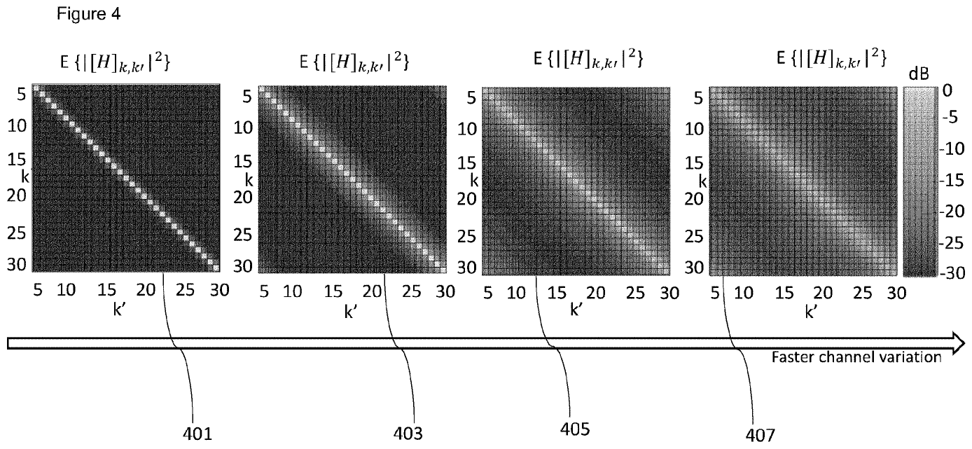

Under slowly-varying channels, H is nearly diagonal, with off-diagonal elements having negligible magnitude. As the rate of variation of the channel response increases, so does the magnitude of the off-diagonal elements of H, given rise to the so-called inter-carrier interference (ICI). This effect is illustrated in FIG. 4.

FIG. 4 shows a graphical representation of inter-carrier interference on OFDM reception as the channel rate of variation grows.

In the first graph 401, the channel variation is at the slowest/lowest level. In the fourth graph 407, the channel variation is at the fastest/highest level. The second graph 403 and the third graph 405 have channel variation speeds between the first 401 and fourth graphs 407.

As seen in the fourth graph 407, the effects of ICI are greater than in the first graph 401 when the channel variation is lower/slower. The speed of channel variation is approximately proportional to the amount of ICI effect.

ICI can severely degrade symbol detection performance in OFDM when it is not accounted for in the processing of received signals. Previous systems disclose many methods for equalization and/or mitigation of ICI-impaired OFDM systems, but the vast majority of works assume that the fast time-varying channel response is perfectly known or can be accurately estimated. However, in practice, the estimation of such time-varying channels may be cumbersome. Furthermore, this typically requires iterative channel estimation and detection algorithms. The difficulty to estimate fast time-varying channels in OFDM systems stems from two points:
i) Since the channel is not static over the OFDM symbol duration, multiple channel impulse responses should be estimated (ideally one per sample time). Alternatively, if estimation is attempted directly in the frequency domain, the estimation of a matrix of dimensions equal to the number of subcarriers should be estimated. This is in contrast to simply estimating its diagonal elements in ideal conditions.
ii) In 3GPP systems, channel estimation is typically based on reference signals which, in fast time varying conditions, are also subject to interference, hence degrading the estimation performance.

The usage of deep learning techniques for receiver algorithms dealing with high-speed channels has drawn a certain attention by the research community in the last years.

In previous systems, an equalizer for large Doppler spread channels was proposed. This system leverages a ‘CascadeNet’ structure whereby a first zero-forcing equalization is applied, followed by an ML driven refined estimate of the transmitted symbols. ‘CascadeNet’ is the given name because the neural network part has a sequential structure, which can be seen as a concatenation (cascade) of blocks performing the same operations a number of times. However, this system disregards the channel estimation process, as it assumes full channel knowledge at the received, including ICI.

In other known systems, an unfolded deep neural network for high mobility channel estimation is used. The channel estimation is modelled as a two-dimension (delay, Doppler) compressed sensing problem, and the neural network is trained assuming that all data symbols are known. In this system, the signal model neglects ICI. Moreover, it is assumed the true delays lie on a predefined grid, which is not realistic in practical conditions.

In other known systems, a linear receiver provides an initial estimate of the data and of the channel response. Afterwards, a cascade of a deep neural network (DNN) and a two-dimensional residual neural network is used for refining the channel estimate. However, this system relies on a preliminary linear interpolation of the least square channel estimates, which results in information loss in the presence of ICI. Furthermore, the ICI is only implicitly considered in the input of the DNN by vectorizing the estimated data symbols together with the received signal in a set of neighbour subcarriers. This system does not exploit a signal model which explicitly takes into account the time variation across an OFDM symbol.

It has been identified that there is a need to improve receiver performance for ‘fast’ time-varying channel conditions. One or more of the following examples aim to address one or more of the problems identified above.

In examples, there is provided a receiver that is configured to obtain received signal samples, determine, for the received signal samples, a channel impulse response estimate based on i) at least one basis expansion model expansion coefficient, and ii) at least one basis function, wherein the at least one expansion model expansion coefficient is associated with a basis expansion model of a channel impulse response; and perform an equalization using the received signal samples, and the channel impulse response estimate. This will be described in more detail below.

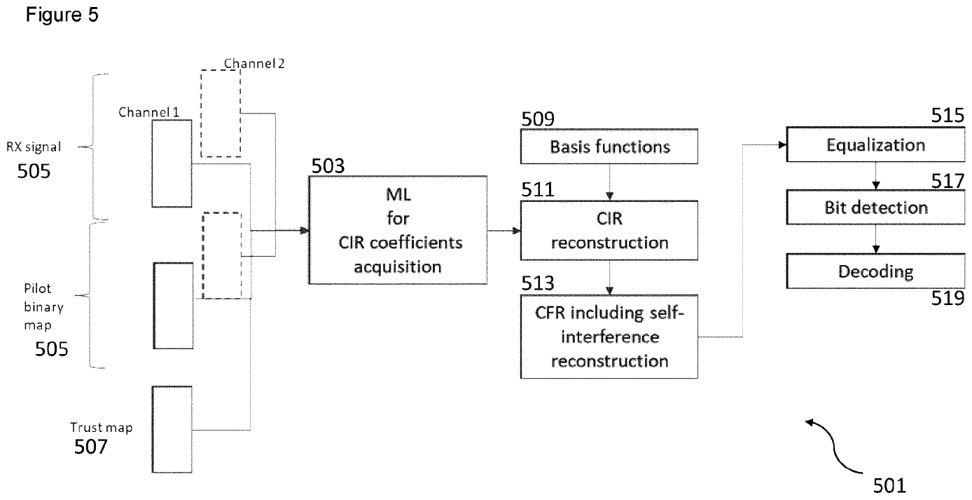

Some examples include a hybrid receive (RX) architecture combining ML and traditional RX processing for OFDM systems under ‘fast’ time-varying channels. This is depicted in FIG. 5.

FIG. 5 shows a schematic representation of the hybrid receiver. The receiver 501 is able to receive OFDM signals (i.e. it is an OFDM receiver). The receiver 501 may receive other signal types in other examples.

The receiver 501 comprises an ML channel estimator 503 for fast time-varying channels, which provides estimates of the time-varying, sampled channel impulse response (CIR). The estimator 503 provides a CIR estimate for each received sample 505 within an OFDM symbol. The ML channel estimator 503 exploits a decomposition of the CIR using a predefined basis expansion model (BEM). The estimator 503 uses a convolutional neural network (CNN) that has, as an input, the received signal 505 over a sequence of OFDM symbols. A pilot map 507 comprising the values and positions of pilot symbols is a further input to the estimator 503. A trust map 507 describing the amount of uncertainty that the receiver has on the modulated symbols (both pilots and data) is a further input to the estimator 503. In some examples, the estimator may not receive the trust map 507.

The CNN of the estimator 503 is configured to estimate one or more expansion coefficients for the BEM. The BEM coefficients are used together with one or more predefined basis functions 509, to reconstruct the desired CIR estimates 511.

In this example, the Slepian basis is used as the basis function 509. Slepian basis is also known as Discrete Prolate Spheroidal Functions (DPSS). Other possible basis that can be used are: the discrete cosine transform (DCT) basis, the discrete Fourier transform (DFT) basis, or the discrete Wavelet transform (DWT) basis.

Based on the CIR estimates, a channel frequency response (CFR) estimate accounting for ICI is reconstructed, which can then be used to perform ICI-aware symbol equalization 515, bit detection 517 and decoding 519. Once the decoding 519 has been performed, the receiver is able to estimate transmitted (data) codewords from the received signal 505.

Weights of the CNN in the estimator 503 may be trained based on knowledge of the true time-varying channel response, in some examples. Alternatively, the training can be based on the end-receiver performance by comparing the detected or decoded bits with the true transmit bit stream.

In the receiver 501 of FIG. 5, the use of a BEM reduces the dimensionality of the ML-based estimation process, rather than estimating all CIR taps at each sample time in an OFDM symbol. In examples, only one or more BEM expansion coefficients need to be determined by the CNN. This allows for a moderate-size CNN. To obtain a description of the ICI, a CIR estimate should be obtained at each sample of each OFDM symbol in the slot. The receiver 501 obtains such a fine-resolution estimate by first estimating only a few (or even 1) coefficients of the BEM expansion. Those BEM expansion coefficients are then used in combination with the basis functions 509 to reconstruct the fine-resolution CIR estimates 511 at each sample of each OFDM symbol in the slot. The receiver 509 estimates only a few BEM expansion coefficients, but these BEM expansion coefficients are fed to an expansion that provides the required CIRs for each sample.

The use of the trust map 507 allows the CNN to weight each element of the received signal 505 according to the uncertainty the receiver 501 has in the symbols that have originated it.

The estimator 503 has the ability to train the CNN not only based on ground truth (known CIRs) but also based on known transmitted bit sequences. This allows, for training, the receiver model in the lab based on channel emulation hardware using the mean squared error (MSE) of the CIR estimates as a loss function, or in the field, based on correctly decoded transmissions using binary cross-entropy of the detected bits as loss function.

The configuration of the receiver 501, and the various function blocks, will be described in more detail below.

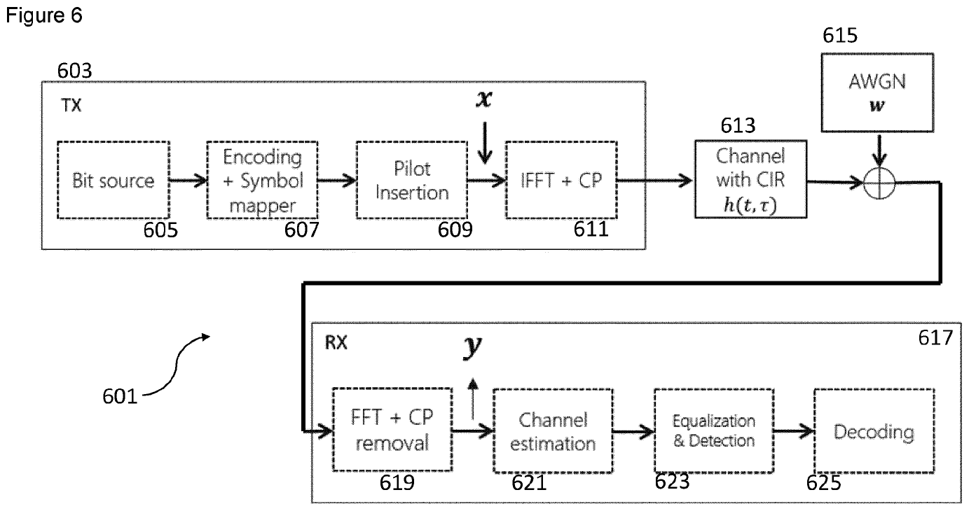

A receiver algorithm for OFDM signals under rapidly time-varying channels is considered, with the system model as depicted in FIG. 6.

FIG. 6 shows a schematic representation of a transmitter in communication with a receiver using OFDM.

The system 601 comprises a transmitter 603. The transmitter 603 has a bit source 605. The transmitter is configured to encode a sequence of bits of the bit source 605 using a channel code. For example, a low-density parity check code is used as the channel code.

The transmitter 603 also has an encoding and symbol mapper 607. The mapper 607 takes the resulting codeword as an input, which is mapped to complex modulation symbols. In examples, the codeword is mapped to the symbols using phase-shift keying (PSK) or quadrature amplitude modulation (QAM) constellations.

The transmitter 603 also has a pilot inserter 609. The output from the mapper 607 is then multiplexed with pilot/reference symbols used for channel estimation by the pilot inserter 609 (e.g., demodulation reference signals). The pilot inserter 609 outputs a vector of data and pilot symbols x.

The transmitter 603 also has an inverse fast Fourier transform (IFFT) processing and cyclic prefix block 611, which is referred to as the proceeding block 611. The resulting vector of data and pilot symbols (x) is then OFDM modulated by (the processing block 611) inverse fast Fourier transform processing and the addition of a cyclic prefix (CP).

The OFDM signal 613 is then transmitted, by the transmitter 603 to a receiver 617, over a time-varying channel with impulse response (CIR) described by h[n, l], n=0, 1, . . . , N−1, l=0, 1, . . . , L−1, where N is the duration (in samples) of the considered OFDM symbol and L is the number of channel taps. The channel also adds additive white Gaussian noise (AWGN) 615 to the signal.

At the receiver 617, the OFDM signal from the transmitter 603 is received. The receiver 617 has a fast Fourier transform (FFT) and CP removal block 619. The received signal is OFDM demodulated by the FFT and CP removal block 619. The FFT and CP removal block 619 first removes the CP, before a FFT is performed. The output from the FFT and CP removal block 619 yields the received signal:

$$y = H x + w$$

where the frequency-domain channel matrix H has entries given by

$${[ H ]}_{k , {k}^{′}} = \frac{1}{N} {\sum }_{n = 0}^{N - 1} {\sum }_{l = 0}^{L - 1} h [ n , l ] exp ( - j 2 π / N ( kn + {k}^{′} l - {k}^{′} n ) ) , k , {k}^{′} = 0 , 1 , … , N - 1.$$

Typically, a transmitted codeword is encoded across multiple OFDM symbol transmissions, resulting in a transmission time interval (TTI) or slot of OFDM symbols.

The receiver 617 also has a channel estimation block 621, an equalization and detection block 623, and a decoding block 625.

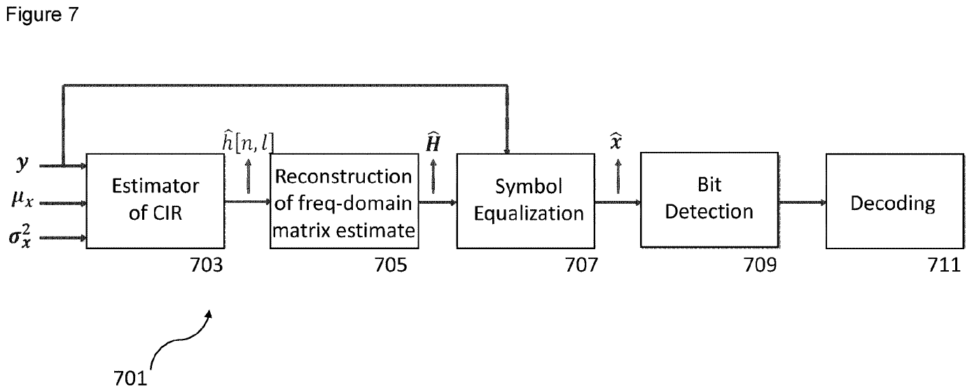

Following the generation of the received signal y, the CIR will be estimate by the channel estimation block 621. Following this, symbol equalization and bit detection are performed by the equalization and detection block 623. Finally, decoding will be performed by the decoding block 625 in order to determine the bits that were sent by the transmitter 603. These steps will be described in more detail below, alongside FIG. 7.

FIG. 7 shows a schematic representation of functional blocks within a receiver. The receiver 701 of FIG. 7 may be similar to the receiver 617 of FIG. 6.

The receiver 701 processes received frequency domain signals y corresponding to all OFDM symbols in a slot, and operates according to the functional blocks in FIG. 7.

The receiver 701 comprises a first processing block 703. The received signals y are an input for the first processing block 705. The received signals y may also be referred to as received signal samples y. A pilot map μₓ is also an input to the first processing block 703. A trust map

$${σ}_{x}^{2}$$

is also an input to the first processing block 703.

In some examples, the trust map is not input into the first processing block 703. The pilot map μₓ and the trust map

$${σ}_{x}^{2}$$

will be discussed in more detail below.

The first processing block 703 is configured to, for the received signal samples y, determine a channel impulse response (CIR) estimate ĥ. The first processing block 703 may use at least one expansion coefficient, and at least one basis function in order to determine the CIR estimate ĥ. The at least one expansion coefficient is associated with a basis expansion model of a (true) CIR.

In some examples, a deep neural network (DNN) of the first processing block 703 provides estimates of the CIR, ĥ[n, l], for all L CIR taps and with n ranging over the duration of the whole slot of OFDM symbols. n is the duration (in samples) of the considered OFDM symbol and L is the total number of channel taps. It is assumed that the maximum CIR duration is L samples (or L taps). l is used to index to one or more of the CIR taps.

The DNN estimating the (time-varying) CIR ĥ taps is based on a basis expansion model (BEM) of the ‘true’ CIR. Such a BEM approximates the CIR values as:

$$h [ n , l ] \approx \tilde{h} [ n , l ] = {\sum }_{d = 0}^{D - 1} {u}_{d} [ n ] {γ}_{d}^{( l )}$$

where u_{d} [n], d=0, 1, . . . , D−1 are a set of basis functions or sequences with n spanning over the number of samples of duration of the slot or TTI. The basis functions may be precalculated or predefined in the receiver 701. D is the model order. In some examples, the Slepian basis is used as the basis function. Slepian basis is also known as discrete prolate spheroidal functions (DPSS). Other possible basis that can be used are: the discrete cosine transform (DCT) basis, the discrete Fourier transform (DFT) basis, or the discrete Wavelet transform (DWT) basis.

The expansion coefficients of the BEM,

$${γ}_{d}^{( l )} , d = 0 , 1 , … , D - 1 , l = 0 , 1 , … , L - 1 ,$$

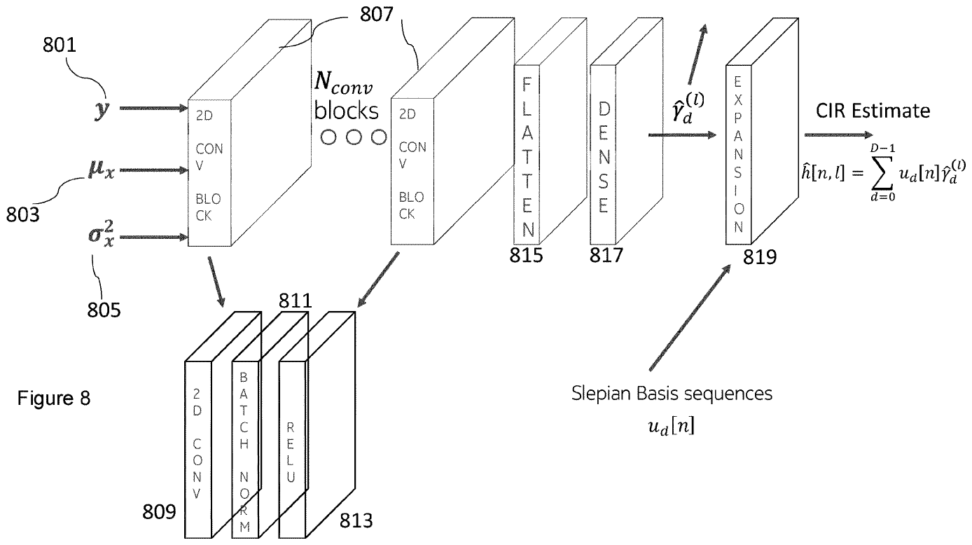

are estimate by the DNN with a structure according to FIG. 8. This will be discussed in more detail below. The expansion coefficients of the BEM are complex numbers.

The first processing block 703 outputs the estimates of the CIR ĥ. In some examples, a CIR estimate ĥ is determined for each sample within the received signal samples y. The output from the first processing block 703 is provided to a second processing block 705.

The second processing block 705 is configured to determine frequency domain channel response estimates Ĥ using the CIR estimates ĥ. In some examples, the second processing block 705 functions as a reconstruction block that translates the estimates of the CIR ĥ into frequency-domain channel matrix representations Ĥ according to

$${[ \hat{H} ]}_{k , {k}^{′}} = \frac{1}{N} {\sum }_{n = 0}^{N - 1} {\sum }_{l = 0}^{L - 1} \hat{h} [ n , l ] exp ( - j 2 π / N ( kn + {k}^{′} l - {k}^{′} n ) ) ,$$

$$k , {k}^{′} = 0 , 1 , … , N - 1 .$$

The second processing block 705 outputs the frequency domain channel response estimates Ĥ.

A third processing block 707 receives the frequency domain channel response estimates Ĥ as an input. The third processing block 707 also receives the received signal samples y as an input. The third processing block 707 is configured as a symbol equalizer which, for the received signal samples y, using the frequency domain channel response estimates Ĥ provides equalised symbol estimates \hat{x}.

In examples, the third processing block 707 may be configured with three different types of equalizers that can be used with the receiver 701.

In a first example, the third processing block 707 comprises a ‘conventional’ equalizer. In this first example, the receiver 701 uses a one-tap equalizer that neglects inter-carrier interference between subcarriers. In this case, the symbol transmitted at the kth subcarrier of a given OFDM symbol in the slot is equalised as

$$\text{?} = \frac{{y}_{k}}{{[ \hat{H} ]}_{k , k}} .$$

In this first example, the matrix Ĥ is still estimated while accounting for ICI. However, only entries H[i, i] in the diagonal of H is used in the equalizer of the third processing block 707. This is the part of the processing that does not relate to ICI. In a square matrix (such as H), the diagonal of the matrix corresponds to the entries of H that have the same index for their column and row indices. That is, the diagonal elements of a matrix ‘N×N’ matrix H are the elements of matrix H[i, i], with i ranging as i=0, 1, . . . , N−1.

In a second example, the third processing block 707 comprises a linear ICI-aware equalizer. In this second example, all symbols in an OFDM symbol are equalized jointly using the linear equalizer. Two possible options are: the zero-forcing (ZF) equalizer \hat{x}=(ĤĤ)⁻¹Ĥ^{H}y, and/or a linear minimum mean square error (LMMSE) equaliser

$$\hat{x} = {( \hat{H} {\hat{H}}^{H} + {σ}_{x}^{2} I )}^{- 1} {\hat{H}}^{H} y .$$

In a third example, the third processing block 707 comprises an iterative detection and ICI cancellation equalizer, which uses an iterative equalization scheme. An initial round of detection is performed using either the ‘conventional equalizer’ of the first example or a linear ICI-aware equalizer of the second example. In subsequent rounds, each symbol is re-detected after the ICI from other symbols has been removed from the received signal using the estimates of the interfering symbols from the previous detection rounds.

For the third example, it is assumed that there is i) an estimate Ĥ of the CFR matrix, and ii) an estimate \hat{x} of the transmitted symbol in an OFDM symbol, available to the iterative equalizer. Then, using these, the equalizer can cancel the ICI in subcarrier k by performing the operation:

$${r}_{k} = {y}_{k} - {\hat{H}}_{k}^{T} * {\hat{x}}_{\{ ∼ k \}}$$

where yₖ is the signal received at the kth subcarrier, Hₖ_{^{T}} is the kth row of the CFR estimate Ĥ, and x_{{~k}} is a vector equal to the symbol estimates x, but with the kth element set to zero. Hence, the term Hₖ_{^{T}}*x_{{~k}} contains estimates of the ICI that all symbols other than the kth symbol impose on the kth received subcarrier. The resulting signal rₖ has that estimate of ICI removed, which provides a better opportunity to correctly detect the kth symbol in the further processing blocks of the receiver 701.

The receiver 701 also has a fourth processing block 709. The fourth processing block 709 may comprise a bit detector. The fourth processing block 709 takes the equalised symbol estimates \hat{x} (from the third processing block 707) as an input. The fourth processing block 409 determines log-likelihood ratios (LLRs) using the equalized symbol estimates \hat{x}.

The fourth processing block 409 may operate on a per data symbol basis. For each data symbol transmitted in a data resource element (RE), the fourth processing block 409 provides the LLRs of each of its constituent bits (for example, 2 bits for Quadrature Phase Shift Keying (QPSK), 4 bits for 16 quadrature amplitude modulation (QAM), 6 bits for 64QAM, etc.).

The receiver 701 also has a fifth processing block 711. The fifth processing block may comprise a decoder. The fifth processing block 711 takes, as inputs, the LLRs obtained from the fourth processing block 709. The fifth processing block 711 uses/utilises the input LLRs to determine estimates of transmitted codewords associated with received signal samples y. In this way, the fifth processing block 711 makes decision on information bits within the received signal samples y.

The fifth processing block 711 may use the LLRs from the fourth processing block 709 to produce, as outcomes, the LLRs of original (transmitted) information bits. Using those LLRs of the information bits, the fifth processing block 711 can determine whether each bit is 1 or 0 can be taken. In this way, the equalized symbol estimates \hat{x} are used to estimate transmitted codewords associated with the received signal samples y.

FIG. 8 shows a schematic representation of function blocks of a deep neural network (DNN) used to determine channel impulse response estimates. FIG. 8 shows, in more detail, the steps performed by the first processing block 703 in order to estimate CIRs.

In this example, the determination of the CIRs uses a DNN. In other examples, a convolution neural network may be used. In other examples, other suitable processing means are used to estimate the CIRs.

In FIG. 8, the DNN takes three inputs: received signal samples y, a pilot map μₓ, and a trust map

$${σ}_{x}^{2} .$$

In some other examples, the DNN does not have the trust map

$${σ}_{x}^{2}$$

as an input.

y 801 (i.e. the signal samples) is a 2D-tensor with dimensions equal to the number of OFDM symbols in a slot, N_{sym}, and the number of subcarriers in an OFDM symbol, N_{sub}. y 801 has two channels, for the real and imaginary parts of the signal.

μₓ 803 (i.e. the pilot map) is a 2D-tensor with the same dimensions as y 801 (i.e. dimensions equal to the number of OFDM symbols in a slot, N_{sym}, and the number of subcarriers in an OFDM symbol, N_{sub}). Similarly, μₓ 803 has two channels for the real and imaginary parts. In entries corresponding to data resource elements (REs), μₓ 803 has values 0. In the entries corresponding to pilot REs, μₓ 803 contains the values of the corresponding pilot symbols.

$${σ}_{x}^{2}$$

805 (i.e. the trust map) is a 2D-tensor with the same dimensions as y 801 (i.e. dimensions equal to the number of OFDM symbols in a slot, N_{sym}, and the number of subcarriers in an OFDM symbol, N_{sub}).

$${σ}_{x}^{2}$$

805 has a single channel, as it contains real numbers (i.e. it does not contain any imaginary numbers/parts).

$${σ}_{x}^{2}$$

805 has values 1 for the entries corresponding to data REs.

$${σ}_{x}^{2}$$

has values of 0 for the entries corresponding to pilot REs. The DNN comprises a number of different functional layers, as follows:
i) A plurality, N_{conv}, of 2D-convolutional blocks 807. The first 2D-convolutional block 807 of the plurality of 2D-convolutional blocks 807 receives, as an input, the signal samples, a pilot map, and optionally, a trust map. The output from the first 2D-convolutional block 807 is then provided as an input to the second 2D-convolutional block 807, and so on. Each of the 2D-convolutional blocks 807 comprises:

A 2D convolution layer 809. The 2D convolution layer 809 takes, as an input, a 2D tensor. The 2D convolution layer 809 provides, as an output, a further 2D tensor. The function of the 2D convolution layer 809 is to implement a 2-D filter that operates as a sliding window over the input 2-D tensor. The filter contains a 2D kernel of size N1×N2 coefficients, which is smaller than the dimensions of the 2D tensor it is applied to. Then, the output of the filter is obtained by sequentially applying the 2D kernel to portions of the 2D tensor, in such a way that the kernel is ‘slid’ through the 2D tensor. For example, the filter may slide from left to right, and from up to down.

A batch normalization layer 811. The batch normalization layer 811 accounts for different scales that the inputs may have. It takes, as an input, a 2-D tensor, and outputs a 2-D tensor of the same dimensions. The output is normalized with an average magnitude obtained over a batch.

A rectified linear unit (RelU) activation unit 813. The RelU activation unit 813 has the function of introducing a non-linear transformation (contrary to the previous layers). Such a non-linear transformation allows the neural network to approximate one or more mathematical functions, regardless of its particular form. It operates element-by-element on the input. The output of the RelU activation unit 813 is of the same size as the input. In this example, the RelU activation unit 813 operates on 2-D tensors. The output is therefore also a 2D tensor.
ii) A flattening layer 815 that converts the 2D tensor at the output of the last 2D-convolutional block into a 1D tensor.
iii) A fully-connected (or dense) layer 817 with a number of output neurons equal to twice the number of estimated basis expansion model coefficients

$${γ}_{d}^{( l )} .$$

The number of output neurons is twice the number of the estimated basis expansion model coefficients

$${γ}_{d}^{( l )}$$

to account for both real and imaginary part of the coefficients. The fully-connected layer 817 is configured to adjust the dimensionality of the signal processed by the neural network to the desired output dimensions, by calculating linear combinations of the elements at its input. The fully-connected layer 817 takes, as an input, a 1-D tensor, and outputs a 1-D tensor that is equal to twice the number of estimated BEM coefficients. In this way, it is the fully-connected layer 817 that outputs the estimated BEM coefficients

$${γ}_{d}^{( l )} .$$

iv) An expansion layer 819. The expansion layer 819 is non-trainable layer that multiplies the output of the fully-connected layer 817 (i.e. the estimated BEM coefficients) with one or more basis functions. The basis functions may be Slepian basis sequences. The output of the expansion layer 819 is estimates of the CIR given by

$$\hat{h} [ n , l ] = {\sum }_{d = 0}^{D - 1} {u}_{d} [ n ] \text{?}$$

The DNN used in FIG. 8 may be trained using data obtained from, for example, field measurements, live networks, or generated using simulation tools. Independently of how the training data has been generated, the DNN can be trained using two alternative strategies. In a first example, end-to-end training used. In a second example, regression-based training is used. In both examples, training of the DNN is performed offline using a large training dataset, with a stochastic gradient descent-based learning algorithm, with a learning rate that is progressively decreasing over training iterations. An example of a stochastic gradient descent-based learning algorithm is an Adam optimizer. Further examples of suitable algorithms are a Stochastic gradient descent algorithm, a root mean square propagation algorithm, am AdaDelta algorithm, an AdaGrad algorithm and an AdaMax algorithm.

In examples, the training dataset used in end-to-end training and/or regression-based training comprises a set of examples and associated labels. The example (from the set of examples) is one data block that may be fed to the DNN/network for training, which in this case is made up of the received signals over an OFDM slot. The label is associated to each example. There may be a label which indicates the true CIR/true transmitted bits from which the example was generated. The labels are used to calculate the loss function of the network, based on which of the trainable parameters are optimized.

In both training strategies, the examples of the set of examples are made of instances of the received signals y over a given OFDM slot. The examples of the set of examples may be obtained in ‘fast’ time-varying channel with diverse signal-to-noise ratio conditions. The speed of the time-varying channel may be defined in terms of a relation between a maximum Doppler frequency (which depends on the system's carrier frequency and the speed of the transceivers) and an OFDM symbol duration (which depends on the employed OFDM system configuration). As an example, a channel may be considered ‘fast’ time-varying if the normalized Doppler frequency, calculated as D_max=f_max*T_s, wherein ‘f_max’ is the maximum Doppler frequency and ‘T_s’ is the OFDM symbol duration) exceeds 0.05. In other examples, a channel may be considered ‘fast’ time-varying if the normalized Doppler frequency exceeds 0.1.

In addition, the positions and values of the pilot symbols transmitted in the slot are also part of the dataset, so that the tensors μ_{y} and

$${σ}_{y}^{2}$$

can be constructed. The labels may differ in the two proposed training methods. Both training strategies are described in more detail below.

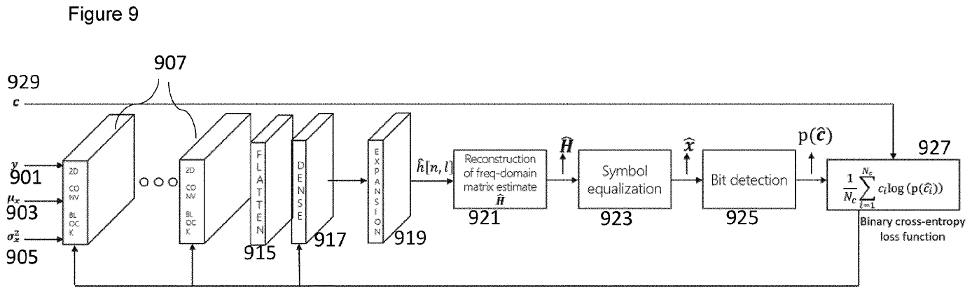

FIG. 9 shows a schematic representation of an end-to-end training loop for a deep neural network.

The end-to-end (E2E) training loop comprises the same functional blocks that are comprised within FIG. 8. These functional blocks are configured in the same manner as described above for FIG. 8.

The E2E training loop comprises a plurality, N_{conv}, of 2D-convolutional blocks 907. The 2D-convolutional block 901 takes, as an input signal samples y 901, a pilot map μₓ 903, and a trust map

$${σ}_{x}^{2}$$

905.

The E2E training loop also comprises a flattening layer 915, a fully-connected (or dense) layer 917, and an expansion layer 919. The expansion layer 919 outputs estimates of CIRs which are input into an matrix estimate block 921. The matrix estimate block 921 has a similar configuration/function to block 705 of FIG. 7. The matrix estimate block 921 outputs frequency domain channel response estimates Ĥ to a symbol equalisation block 923. The symbol equalisation block 923 has a similar configuration/function to block 707 of FIG. 7. The symbol equalisation block 923 outputs equalised symbol estimates \hat{x} to a bit detection block 925. The bit detection block 925 has a similar configuration/function to block 709 of FIG. 7. The bit detection block 925 outputs predictions of transmitted codewords p(ĉ). The codeword predictions can be compared to known codewords c using a processing block 927. The processing block 927 uses a binary cross-entropy loss function, with the predictions of transmitted codewords p(ĉ) and the known codewords c. The output from the processing block 927 is provided to the 2D convolutional layers 907, and the fully-connected layer 917.

In this way, in E2E training, the DNN is trained using a binary cross-entropy loss function between the transmitted bits after channel coding and the bit probabilities p(ĉ) at the output of the receiver's bit detector. Such training uses a soft bit detector that produces bit probabilities for all N_{c} bits of the transmitted codeword c. The gradients of the loss function with respect to the DNN trainable parameters are calculated using back-propagation through all the receiver chain in order to perform gradient upgrade steps on the DNN trainable parameters. The trainable parameters are the weights of the 2D convolutional layer 907, and the fully-connected layer 917. The gradient of the loss function with respect to such parameters may be calculated using a standard backpropagation algorithm, and the gradient may be used to update the weights using a neural network optimizer. For example, a stochastic gradient descent (SGD), Adam, or any other suitable option, may be used as the neural network optimizer.

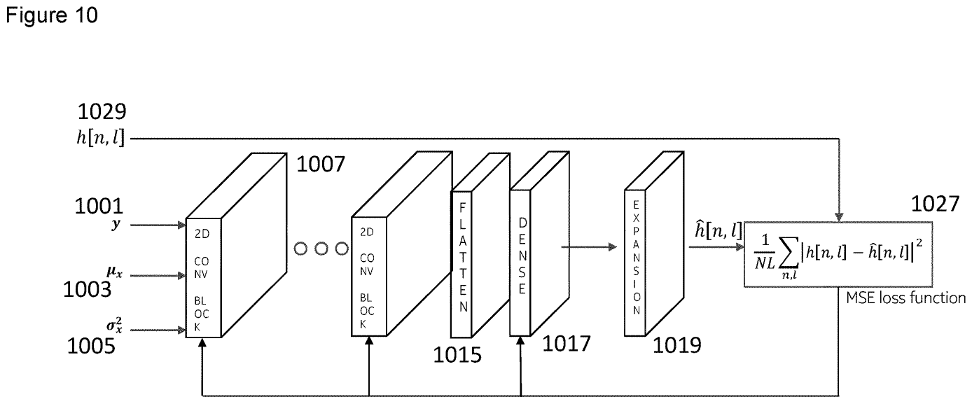

FIG. 10 shows a schematic representation of regression-based training loop for a deep neural network.

The regression-based (RB) training loop comprises the same functional blocks that are comprised within FIG. 8. These functional blocks are configured in the same manner as described above for FIG. 8.

The RB training loop comprises a plurality, N_{conv}, of 2D-convolutional blocks 1007. The 2D-convolutional block 1001 takes, as an input signal samples y 1001, a pilot map μₓ 1003, and a trust map

$${σ}_{x}^{2}$$

1005.

The RB training loop also comprises a flattening layer 1015, a fully-connected (or dense) layer 1017, and an expansion layer 1019. The expansion layer 1019 outputs estimates of CIRs, h[n, l], which are input into an processing block 1027. The processing block 1027 uses an MSE loss function with the estimated CIRs, ĥ[n, l], and ‘true’ CIRs, h[n, l] 1029. The output from the processing block 1027 is a measure of discrepancy between the ‘true’ CIR and the CIR, h[n, l], estimated by the neural network.

In RB training, the DNN is trained using a mean-squared error (MSE) loss function between the CIR estimates, ĥ[n, l], provided by the DNN and a ‘true’ CIR h[n, l]. The ‘true’ CIR, h[n, l], is the correct or real CIR, compared to an estimate of the CIR (determined according to previous examples.). The loss function gradient with respect to the DNN training parameters may be computed using a standard back-propagation algorithm in order to perform gradient upgrade steps on the DNN trainable parameters. The trainable parameters are the weights of the 2D convolutional layer 1007, and the fully-connected layer 1017. The gradient of the loss function with respect to such parameters may be calculated using a standard backpropagation algorithm, and the gradient may be used to update the weights using a neural network optimizer. For example, a stochastic gradient descent (SGD), Adam, or any other suitable option, may be used as the neural network optimizer.

This RB training strategy uses knowledge of the ‘true’ CIR, h[n, l]. The ‘true’ CIR, h[n, l], may be obtained using data generated via computer simulation. For training with field measurements or live network data, accurate estimates of the CIR for the training data are obtained and used. For example, the accurate estimates of CIR may be obtained using high-quality channel sounding equipment, as well as signal processing methods to obtain the CIRs.

One or more of the previous examples, with the use of the BEM, allows the use of a moderate-size DNN for estimation of the BEM coefficients. This leads to less data and less training being needed compared to larger-size models. This means that the complexity of running the DNN in inference mode is also improved (i.e. reduced complexity).

Further, the channel estimator can provide accurate CIR/CFR estimates without complex, iterative estimation and detection processing. The estimates provided by the DNN and/or BEM-based estimator can be used for ICI-aware equalization, contrary to classical channel estimators.

In addition, to further improve the CIR/CFR estimates, the channel estimator can also be incorporated in an iterative estimation and detection fashion, by appropriately updating the trust map after each detection iteration.

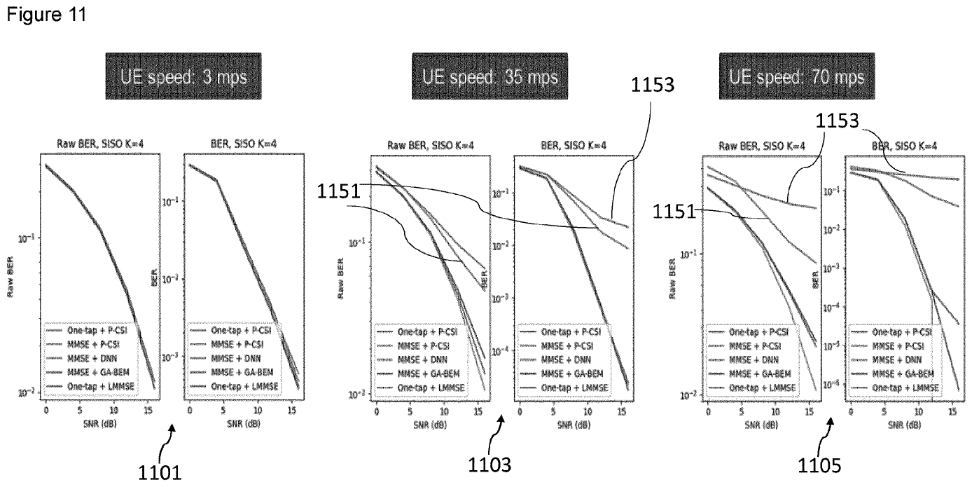

The channel estimator and receiver structure leads to an improved receiver performance that is better than ‘standard’ receivers, and closer to that of idealistic benchmarks in fast time-varying channel conditions. In addition, the receiver structure of the previous examples performs as well as ‘standard’ receivers in slow time-varying channels. To illustrate this, FIG. 11 shows a set of simulation results obtained with one example of the proposed receiver with multiple relevant benchmarks. For the simulations, the following OFDM system and channel parameters were used:

### OFDM Parameters:

6 PRBs made of 12 subcarriers×14 OFDM symbols each.
15 KHz subcarriers spacing.
Pilots at 3rd and 12th OFDM symbol, with frequency-spacing of 2 subcarriers.
16QAM modulation.
LDPC code with ½ rate.

### Channel Parameters:

SISO channel, UMi profile at 4.7 GHZ.
UE speeds: 3, 35, and 70 metres/second (m/s).
Generated using QuaDRiGa channel model.
   In these conditions, the following benchmarks are evaluated (shown in Table 1):

| | Equalizer | Channel Estimation |
|---|---|---|
| One-tap + | One-tap | Perfect knowledge of CIR |
| P-CSI | (neglects ICI) | |
| MMSE + | LMMSE | Perfect knowledge of CIR |
| P-CSI | (ICI-aware) | |
| MMSE + | LMMSE | DNN estimation of BEM coeff. |
| DNN | (ICI-aware) | |
| MMSE + | LMMSE | BEM expansion with optimal coeff. |
| GA-BEM | (ICI-aware) | |
| One-tap + | One-tap | 2D LMMSE channel estimator |
| LMMSE | (neglects ICI) | |

The evaluated receivers shown in Table 1, are as follows: MMSE+DNN 1151 is the receiver structure of the previous examples (i.e. FIG. 7). The “One-tap+P-CSI”, “MMSE+P-CSI” and “MMSE+GA-BEM” are idealistic benchmarks with perfect knowledge of the CIR. The “One-tap+LMMSE” 1153 is a standard receiver structure using an LMMSE based channel estimator. Wherein, “P-CSI” is perfect channel state, “GA-BEM” is Genie-Aided basis expansion model, “MMSE” is minimum mean square error, and “LMMSE” is linear minimum mean square error. “One-tap” means that each symbol transmitted in data REs is equalized by multiplying the signal received in the corresponding RE with a single complex coefficient.

The performance of the proposed receiver 1151 (i.e. the receiver of FIG. 7) and the benchmarks are illustrated in FIG. 11 under low (3 metres per second (mps)) 1101, high (35 mps) 1103, and very-high (70 mps) 1105, UE speeds. For each UE speed, two graphs are provided: a raw bit rate error (BER), and a BER. In FIG. 11, a signal-to-noise ratio (SNR) over 0 dB indicates that the signal level is greater than the noise level. The higher the ratio, the better the signal quality. A lower BER error is desired.

As it can be seen, the performance of the proposed receiver (MMSE+DNN) 1151 is, under all conditions, as good as (or better) than that of a state-of-art receiver (e.g. One-tap+LMMSE) 1153. MMSE+DNN 1151 also performs closer to the performance of the idealistic benchmark, particularly in the ‘high’ and the ‘very-high’ mobility conditions.

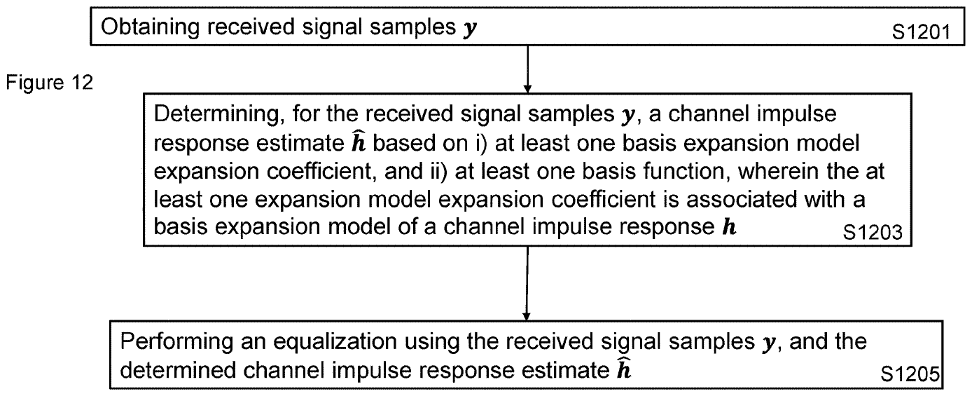

FIG. 12 shows an example method flow performed by an apparatus. The apparatus may be comprised within a receiver. In an example, the receiver is within a UE or terminal. In another example, the receiver is within a base station.

In S1201, the method comprises obtaining received signal samples y.

In S1203, the method comprises determining, for the received signal samples y, a channel impulse response estimate ĥ based on i) at least one basis expansion model expansion coefficient, and ii) at least one basis function, wherein the at least one expansion model expansion coefficient is associated with a basis expansion model of a channel impulse response h.

In S1205, the method comprises performing an equalization using the received signal samples y, and the determined channel impulse response estimate ĥ.

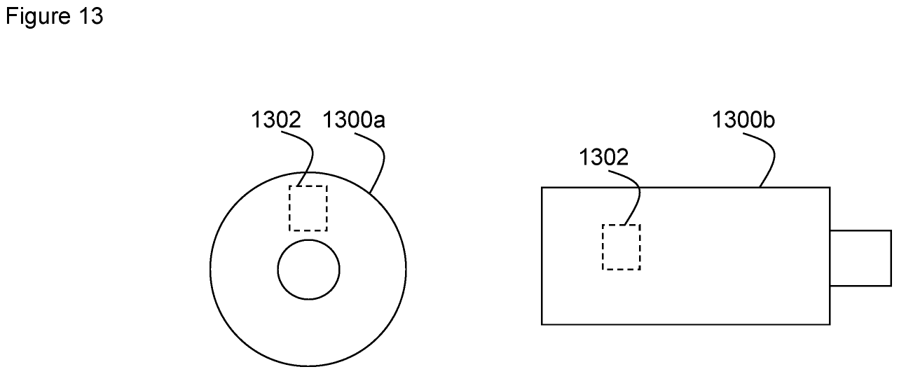

FIG. 13 shows a schematic representation of non-volatile memory media 1300a (e.g. computer disc (CD) or digital versatile disc (DVD)) and 1300b (e.g. universal serial bus (USB) memory stick) storing instructions and/or parameters 1302 which when executed by a processor allow the processor to perform one or more of the steps of the methods of FIG. 12.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following: (a) hardware-only circuit implementations (such as implementations in only analogue and/or digital circuitry); (b) combinations of hardware circuits and software, such as: (i) a combination of analogue and/or digital hardware circuit(s) with software/firmware and (ii) any portions of hardware processor(s) with software (including digital signal processor(s)), software, and memory(ies) that work together to cause an apparatus, such as the communications device or base station to perform the various functions previously described; and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus for a receiver, the apparatus comprising:
a processor; and
a memory including instructions that, when executed by the processor, cause the apparatus to:
obtain received signal samples y;
determine, for the received signal samples y, a channel impulse response estimate ĥ based on at least one basis expansion model expansion coefficient, and at least one basis function, wherein the at least one expansion model expansion coefficient is associated with a basis expansion model of a channel impulse response h; and
perform an equalization using the received signal samples y, and the determined channel impulse response estimate ĥ.

2. The apparatus according to claim 1, wherein performing an equalization includes:
determining a frequency domain channel response estimate Ĥ based on the channel impulse response estimate ĥ;
determining an equalized symbol estimate \hat{x} based on i) the frequency domain channel response estimate Ĥ, and ii) the received signal samples y; and
using the equalized symbol estimate \hat{x} to estimate a transmitted codeword associated with the received signal samples y.

3. The apparatus according to claim 1, wherein determining, for the received signal samples y, a channel impulse response estimate ĥ includes determining, for each sample within the received signal samples y, a channel impulse response estimate ĥ.

4. The apparatus according to claim 1, wherein using the equalized symbol estimate \hat{x} includes:
determining a log-likelihood ratio using the equalized symbol estimate \hat{x}; and
utilising the log-likelihood ratio to determine the estimate of the transmitted codeword associated with received signal samples y.

5. The apparatus according to claim 1, wherein the received signal samples y is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot,
wherein the received signal samples y comprises a first channel and a second channel for real and imaginary parts of the signal y respectively.

6. The apparatus according to claim 1, wherein determining, for the received signal samples y, the channel impulse response estimate ĥ is performed by a deep neural network that receives, as inputs:
the received signal samples y, wherein the received signal samples y includes orthogonal frequency division multiplexing symbol symbols; and
a pilot map μₓ describing values and positions of pilot resource elements within the orthogonal frequency division multiplexing symbol symbols.

7. (canceled)

8. The apparatus according to claim 6, wherein the deep neural network receives, as an input:
a trust map
$${σ}_{x}^{2}$$
describing a confidence level of values and positions of data resource elements within the orthogonal frequency division multiplexing symbols of the received signal samples y.

9. The apparatus according to claim 8, wherein the instructions further cause the apparatus to
determine the at least one basis expansion model expansion coefficient of the basis expansion model using the received signal samples y, and at least one of: the pilot map μₓ, and the trust map
$${σ}_{x}^{2} .$$

10. The apparatus according to claim 6, wherein the pilot map μₓ is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot,
wherein the pilot map μₓ includes a first channel and a second channel for real and imaginary parts of the signal y respectively,
wherein elements of the pilot map μₓ have: a value set to ‘0’ for elements that correspond to data resource elements of the received signal samples y, and a value corresponding to a respective pilot symbol for elements that correspond to pilot resource elements of the received signal samples y.

11. The apparatus according to claim 8, wherein the trust map
$${σ}_{x}^{2}$$
is a tensor with dimensions equal to a number of orthogonal frequency division multiplexing symbols in a slot N_{sym}, and a number of subcarriers in an orthogonal frequency division multiplexing symbol N_{sym} a number orthogonal frequency division multiplexing symbols within an orthogonal frequency division multiplexing slot,
wherein the trust map
$${σ}_{x}^{2}$$
comprises a single channel for real parts of the received signal samples y, and
wherein elements of the trust map
$${σ}_{x}^{2}$$
have: a value set to ‘1’ for elements that correspond to data resource elements of the received signal samples y, and a value set to ‘0’ for elements that correspond to pilot resource elements of the received signal samples y.

12. The apparatus according to claim 6, wherein the deep neural network comprises a series of two-dimensional convolutional blocks, each two-dimensional convolutional blocks includes:
a two-dimensional convolutional layer configured to implement a two-dimensional filter that operates as a sliding window over the input tensor, taking a two-dimensional tensor as an input, and providing an output two-dimensional tensor;
a two-dimensional batch normalization layer configured to account for different scales of the inputs to the deep neural network, by taking a tensor as an input and outputting a tensor of the same dimension, that has been normalized with an average magnitude obtained over a batch; and
a two-dimensional rectified linear unit configured to introduce a non-linear transformation, to allow the deep neural network to approximate mathematical functions, wherein the two-dimensional rectified linear unit operates element-by-element on the input, so that an output is the same size as the input.

13. The apparatus according to claim 6, wherein the deep neural network comprises: a flattening layer configured to convert a two-dimensional tensor provided by a last two-dimensional convolutional block of the series of two-dimensional convolutional blocks into a one-dimensional tensor, and a dense layer configured to, using the one-dimensional tensor output from the flattening layer as an input, output the at least one basis expansion model expansion coefficient.

14. (canceled)

15. The apparatus according to claim 6, where the deep neural network comprises an expansion layer configured to provide the channel impulse response estimate ĥ using i) the at least one basis expansion coefficient, and ii) the at least one basis function.

16. The apparatus according to claim 6, wherein the deep neural network is trained using, at least one of: data obtained from field measurements, data obtained from live networks, and data generated using simulation tools.

17. The apparatus according to claim 6, wherein the deep neural network is trained offline based on a training dataset, using a stochastic gradient descent-based learning algorithm, with a learning rate progressively decreasing over training iterations.

18. The apparatus according to claim 16, wherein the deep neural network is trained based on an end-to-end strategy using:
determining, for a training received signal samples, a channel impulse response estimate ĥ based on a basis expansion model of a channel impulse response h;
determining a frequency domain channel response estimate Ĥ based on the channel impulse response estimate ĥ;
determining an equalized symbol estimate \hat{x} based on i) the frequency domain channel response estimate Ĥ, and ii) the training received signal samples; and
using the equalized symbol estimate \hat{x} to estimate a transmitted codeword associated with the training received signal samples;
determining a probability of a codeword estimate p [symbol] based on the equalized symbol estimate \hat{x};
determining a binary cross-entropy loss based on the probability of a codeword estimate p [symbol] and a codeword c; and
adjusting one or more of: the convolutional block, and the dense layer, based on the binary cross-entropy loss.

19. The apparatus according to claim 16, wherein the deep neural network is trained based on a regression based strategy using:
determining, for a training received signal samples, a channel impulse response estimate ĥ based on a basis expansion model of a channel impulse response h;
determining a mean squared error based on the channel impulse response estimate ĥ and the channel impulse response h; and
adjusting one or more of: the convolutional block, and the dense layer, based on the mean squared error.

20-22. (canceled)

23. The apparatus according to claim 1, wherein the frequency domain channel response estimate Ĥ and the frequency domain equalized symbol estimate \hat{x} are determined iteratively, wherein for each iteration:
the pilot map μₓ is updated by setting the values corresponding to data resource elements to a mean of the estimate of the corresponding data symbol;
the trust map
$${σ}_{x}^{2}$$
is updated by setting the values corresponding to data resource elements to a variance of the estimate of the corresponding data symbol; and
an estimate of inter-carrier interference is removed from the received signal samples y before determining the frequency domain equalized symbol estimate \hat{x}.

24. A method performed by a receiver, the method comprising:
obtaining received signal samples y;
determining, for the received signal samples y, a channel impulse response estimate ĥ based on at least one basis expansion model expansion coefficient, and at least one basis function, wherein the at least one expansion model expansion coefficient is associated with a basis expansion model of a channel impulse response h; and
performing an equalization using the received signal samples y, and the determined channel impulse response estimate ĥ.

25. A computer program comprising computer executable instructions which, when run on one or more processors, configured to:
obtain received signal samples y;
determine, for the received signal samples y, a channel impulse response estimate ĥ based on at least one basis expansion model expansion coefficient, and at least one basis function, wherein the at least one expansion model expansion coefficient is associated with a basis expansion model of a channel impulse response h; and
perform an equalization using the received signal samples y, and the determined channel impulse response estimate ĥ.
